(19) United States
(12) Patent Application Publication
(10) Pub. No.: US 2017/0282491 A1
(43) Pub. Date: Oct. 5, 2017

(54) VEIL-STABILIZED COMPOSITE WITH IMPROVED TENSILE STRENGTH

(71) Applicant: The Boeing Company, Chicago, IL (US)

(72) Inventor: Thomas K. Tsotsis, Santa Ana, CA (US)

(73) Assignee: The Boeing Company, Chicago, IL (US)

(21) Appl. No.: 15/623,630

(22) Filed: Jun. 15, 2017

Related U.S. Application Data
(63) Continuation of application No. 13/753,708, filed on Jan. 30, 2013.

(51) Int. Cl. B32B 5/02; B32B 5/06; C08J 5/24; B32B 37/14; B32B 5/26; B32B 7/02

(52) U.S. Cl. CPC B32B 5/022; B32B 2605/18; B32B 5/26; B32B 7/02; C08J 5/24; B32B 2250/20; B32B 2250/42; B32B 2260/023; B32B 2260/046; B32B 2262/106; B32B 2307/54; B32B 2307/542; B32B 5/028; B32B 2305/72; B32B 2305/20; B32B 2305/076; B32B 2262/02; B32B 37/14; B32B 5/06

(57) ABSTRACT

A method for manufacturing a composite may include: selecting an interlayer material having a first distortional-deformation capability; selecting a matrix material having a second distortional-deformation capability, which is less than the first distortional-deformation capability; disposing at least one reinforcing layer, formed of reinforcing fibers of a reinforcing material, and at least one interlayer, formed of a nonwoven fabric of the interlayer material, in an alternating configuration; and infusing the at least one reinforcing layer and the at least one interlayer with the matrix material such that the matrix material flows though the at least one reinforcing layer and the at least one interlayer. Selection of the interlayer material having the first distortional-deformation capability and the matrix material having the second distortional-deformation capability is configured to increase tensile strength of the composite.

### PRIORITY

This application is a continuation of U.S. Ser. No. 13/753,708 filed on Jan. 30, 2013.

### FIELD

The present disclosure is generally related to cured composites and, more particularly, to veil-stabilized fabrics utilizing an interlayer in conjunction with a reinforcing layer to obtain a cured composite with increased tensile strength.

### BACKGROUND

High-performance composites built of alternating layers of unidirectional reinforcing fibers have an advantageous combination of high strength and light weight. As such they find use in aerospace and other industries where such properties are critical. Generally, the composites are prepared by laying up a number of alternating layers with adjacent layers having unidirectional fibers running at different angles. The net effect of buildup of several layers of such unidirectional fabrics is to provide a composite having exceptional strength, either quasi-isotropically, or in one or more particular directions. Such composites may be produced as prepregs or as preforms.

In the prepreg approach, layers of unidirectional fabrics are immersed or impregnated with a matrix material, such as a resin. The layers may be laid-up into the shape of a final composite part to be produced from the composite. Thereafter, the laid-up composite may be heated to cure the matrix material and provide a finished composite part.

In the preform approach, layers of unidirectional reinforcing fibers or woven, braided, warp-knit, or other types of fabric are laid-up similarly to the way they are laid-up in the prepreg approach. However, in the preform approach, the layers are laid-up dry (i.e., without the matrix material). Thereafter, the laid-up composite is infused with the matrix material in a liquid-molding process and the molded composite part may be heated to cure the matrix material as in the prepreg approach.

Alternating layers, or lamina, of reinforcing fibers provide the composite parts made from prepreg or preform with a great deal of strength, especially in directions that align with specific fiber directions. Accordingly, very strong lightweight parts may be produced, for example, as wings and fuselages of aircraft. The use of interlayers may also be used to improve the fracture toughness and/or the impact resistance of a composite.

Although the alternating lamina of reinforcing fibers or the use of interlayers may provide strength and impact resistance, the tensile strength of the composite is determined mainly by the properties of the reinforcing fibers and their interaction with the cured matrix material. Thus, in order to increase the tensile strength of a composite, higher-strength reinforcing fibers must be used, which may increase cost or specialized resins must be used, which may impact other physical characteristics of the composite.

It has been discovered that a composite polymeric matrix with improved (i.e. increased) distortional-deformation, and/or decreased (i.e. lower) dilatation load, as expressed with the von Mises strain relationship, will increase von Mises strain and provide enhanced composite mechanical performance.

The deformation of matter can be divided into two categories: dilatation (i.e., volume expansion) and distortion. The mechanisms correspond to the elastic and plastic processes occurring in matter under a uniform state of stress. Forces applied to a physical system that result in a volume change are termed elastic and have been adequately described using Hooke's Law. Volume expansion as shown in FIG. 1, is a result of a local loss of intermolecular cohesion and a reduction of density. As long as the displacements are small, the linear restoring force or cohesive strength will reverse the effects on release of the applied force. The cohesive forces in question are also responsible for the thermal contraction with temperature and a direct consequence of the decrease in amplitude of the molecular vibrations as the polymer is cooled. The cohesive forces can be described using a potential function which relates the intermolecular energy of attraction and the separation distance to van der Waals forces and nearest neighbor repulsions.

At a macroscopic level, an isotropic body deforming elastically will expand conforming to the following relations: εv=J₁+J₂+J₃, where J₁=ε₁+ε₂+ε₃, J₂=ε₁ε₂+ε₂ε₃+ε₃ε₁, J₃=ε₁ε₂ε₃, and ε₁, ε₂, and ε₃ are the principal strains. The volume change can be approximated by the first invariant of strain J₁, which represents over 98% of the volume change.

The critical volume expansion capacity is numerically equal to the amount of contraction experienced by the polymer on cooling from its glass-transition temperature. The thermal contraction that is directly relatable to the reduction in thermal energy and the decrease in the equilibrium intermolecular distance represents the maximum elastic expansion potential under mechanical or thermal loading.

It is reasonable to view distortion or a deviatoric response of a material to an applied force as an abrupt shear transformation or cooperative motion of a specific volume or segment of the polymer chain responding to a strain bias. The distorted cube illustrated in FIG. 2 is a simple depiction of distortion.

Polymers within composites can and are often subjected to a force application that severely limits their ability to flow. The constraint imposed by fiber orientations greater than approximately 30° to the principal strain direction will generate a dilatational critical deformation. The lamina orientations with angle differentials less than approximately 25° to the direction of global strain will transition from a dilatational- to a distortional-critical behavior.

The enhanced understanding of the constituent materials deformation behavior has enabled design structures that can take advantage of the unique performance characteristics of composite materials. Analysis and test validation has shown that mechanical loading that favors matrix distortion rather than dilatation allows for a composite-structure-specific performance capability. Particular constituent materials' ultimate strengths however can limit the achievement of maximum performance. For example, testing shows that fiber performance is limited by a low matrix critical distortional capability of the thermoset resins used.

Accordingly, those skilled in the art continue with research and development efforts in the field of composites.

### SUMMARY

In one embodiment, the disclosed veil-stabilized composite may include at least one reinforcing layer, a plurality of interlayers disposed alternately between and bonded to the reinforcing layers, each of the interlayers being formed of an interlayer material having a first distortional-deformation capability, and a matrix material infused in the reinforcing layers and the interlayers, the matrix material having a second distortional-deformation capability, wherein the first distortional-deformation capability is greater than the second distortional-deformation capability to increase tensile strength of the composite.

In another embodiment, the disclosed veil-stabilized composite may include a reinforcing layer including a plurality of unidirectional reinforcing fibers, and a pair of interlayers disposed over the reinforcing layer, each of the interlayers including a plurality of polymeric fibers, wherein the polymeric fibers have a high distortional-deformation capability, and wherein the reinforcing layer and said interlayers are bonded together to form a veil-stabilized fabric.

In yet another embodiment, disclosed is a method for forming a veil-stabilized composite, the method may include the steps of: (1) providing at least one reinforcing layer including a fibrous reinforcing material, (2) positioning at least one interlayer over the reinforcing layer, the interlayer including nonwoven polymeric fibers having a first distortional-deformation capability, (3) bonding the reinforcing layer and the interlayer together to form a veil-stabilized fabric, and (4) infusing the veil-stabilized fabric with a matrix material, the matrix material having a second distortional-deformation capability, and (5) processing this material to cure the matrix material to form a solid composite.

In yet another embodiment, disclosed is a method for manufacturing a composite, the method may include the steps of: (1) selecting an interlayer material having a first distortional-deformation capability, (2) selecting a matrix material having a second distortional-deformation capability, which is less than the first distortional-deformation capability, (3) disposing at least one reinforcing layer, formed of reinforcing fibers of a reinforcing material, and at least one interlayer, formed of a nonwoven fabric of the interlayer material, in an alternating configuration, and (4) infusing the at least one reinforcing layer and the at least one interlayer with the matrix material such that the matrix material flows though the at least one reinforcing layer and the at least one interlayer. Selection of the interlayer material having the first distortional-deformation capability and the matrix material having the second distortional-deformation capability is configured to increase tensile strength of the composite.

In yet another embodiment, disclosed is a method for manufacturing a composite, the method may include the steps of: (1) selecting an interlayer material having a first distortional-deformation capability, (2) selecting a matrix material having a second distortional-deformation capability, which is less than the first distortional-deformation capability, (3) disposing a plurality of reinforcing layers, formed of reinforcing fibers of a reinforcing material, and a plurality of interlayers, formed of a nonwoven fabric of the interlayer material, in an alternating configuration, and (4) infusing the plurality of reinforcing layers and the plurality of interlayers with the matrix material such that the matrix material flows though the plurality of reinforcing layers and the plurality of interlayers. Selection of the interlayer material having the first distortional-deformation capability and the matrix material having the second distortional-deformation capability is configured to provide a cured composite having an overall distortional-deformation capability, which is greater than the second distortional-deformation capability, to increase tensile strength of the cured composite.

In yet another embodiment, disclosed is a method for improving tensile strength of a composite that includes at least one reinforcing layer, formed of reinforcing fibers of a reinforcing material, and at least one interlayer, formed of a nonwoven fabric of an interlayer material, disposed in an alternating configuration and infused with a matrix material, the method may include the steps of: (1) selecting the interlayer material having a first distortional-deformation capability, and (2) selecting the matrix material having a second distortional-deformation capability, which is less than the first distortional-deformation capability. Selection of the interlayer material having the first distortional-deformation capability and the matrix material having the second distortional-deformation capability is configured to increase tensile strength of the composite.

Other aspects of the disclosed veil-stabilized composite will become apparent from the following detailed description, the accompanying drawings and the appended claims.

### BRIEF DESCRIPTION OF THE DRAWINGS

FIG. 1 depicts a perspective view of a cube showing the volume expansion of the cube upon the application of force;

FIG. 2 depicts a perspective view of the cube of FIG. 1 upon the application of a biased strain to the cube;

FIG. 3 is a perspective view of an embodiment of the disclosed veil-stabilized composite;

FIG. 4 is a side view of an embodiment of the veil-stabilized fabric of the disclosed veil-stabilized composite;

FIG. 5 is a detailed cross-sectional view of a portion of the disclosed veil-stabilized composite;

FIG. 6 is a side view of another embodiment of the veil-stabilized fabric of the disclosed veil-stabilized composite;

FIG. 7 is a cross-sectional view of another embodiment of the veil-stabilized fabric of the disclosed veil-stabilized composite;

FIG. 8 is a schematic view of an embodiment of the disclosed system for forming the disclosed veil-stabilized fabric of FIG. 4;

FIGS. 9-12 are section views schematically illustrating example bicomponent fibers of the interlayers of the disclosed veil-stabilized composite;

FIG. 13 is a flow chart illustrating an embodiment of the disclosed method for forming a veil-stabilized composite; and

FIG. 14 is a detailed schematic top-down view of the general morphology of the veil geometry.

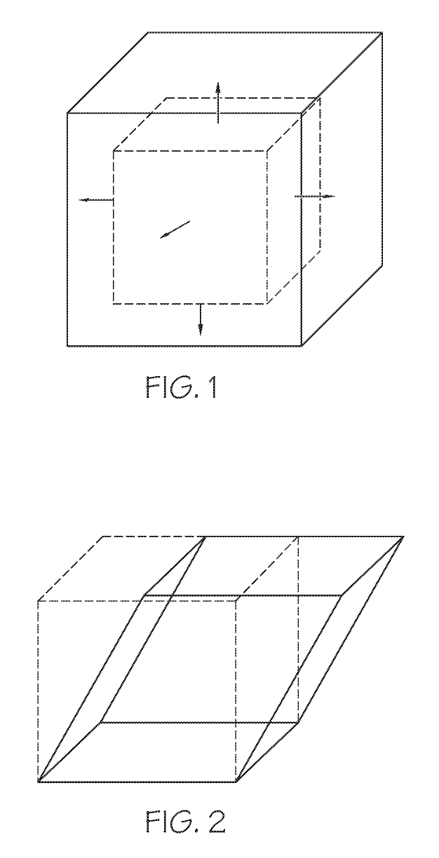

### DETAILED DESCRIPTION

The following detailed description refers to the accompanying drawings, which illustrate specific embodiments of the disclosure. Other embodiments having different structures and operations do not depart from the scope of the present disclosure. Like reference numerals may refer to the same element or component in the different drawings.

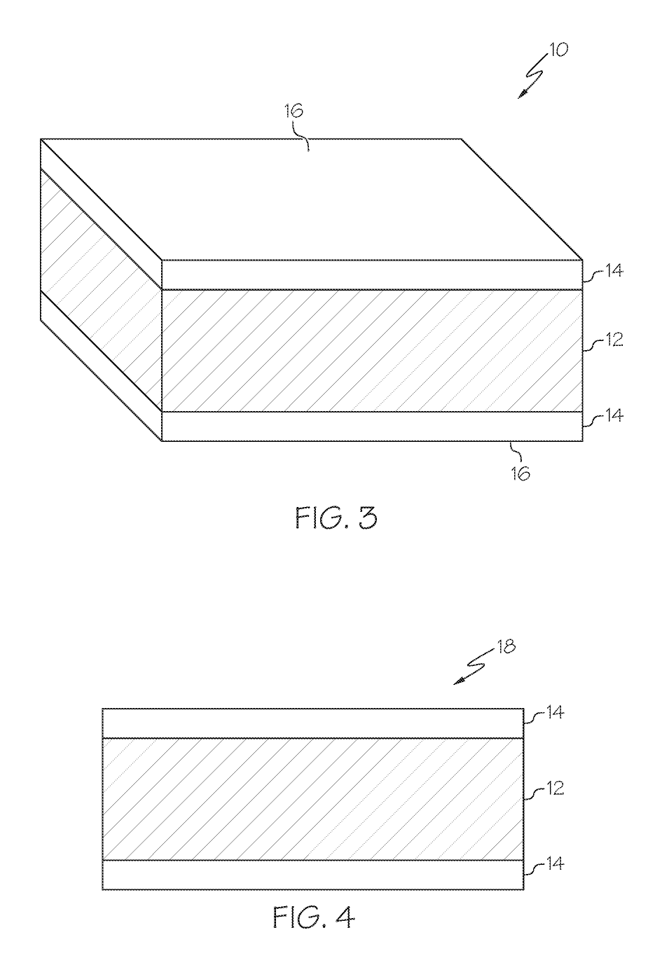

Referring to FIG. 3, one embodiment of the disclosed veil-stabilized composite, generally designated 10, may include a plurality of alternating reinforcing layers 12 and interlayers 14 infused with a matrix material 16. The present disclosure provides veils formed by one or more interlayers 14 that provide increased distortional-deformation, and/or decreased dilatation load, in order to increase the von Mises strain within the composite 10.

Referring to FIG. 4, at least one reinforcing layer 12 may be covered (e.g., over an upper longitudinal surface and over a lower longitudinal surface) by a pair of interlayers 14. The reinforcing layer 12 and the interlayers 14 may be bonded together to form a veil-stabilized fabric 18. The veil-stabilized fabric 18 may be infused with the matrix material 16 (FIG. 3) to impregnate the reinforcing layer 12 and form the composite 10 (FIG. 3).

Referring to FIGS. 3 and 4, the veil-stabilized fabric 18 may have a relatively high distortional-deformation capability compared to the distortional-deformation capability of the surrounding matrix material 16. In a first expression, the distortional-deformation capability of the veil-stabilized fabric 18 may be at least 5 percent greater than the distortional-deformation capability of the surrounding matrix material 16. In a second expression, the distortional-deformation capability of the veil-stabilized fabric 18 may be at least 10 percent greater than the distortional-deformation capability of the surrounding matrix material 16. In a third expression, the distortional-deformation capability of the veil-stabilized fabric 18 may be at least 20 percent greater than the distortional-deformation capability of the surrounding matrix material 16. In a fourth expression, the distortional-deformation capability of the veil-stabilized fabric 18 may be at least 30 percent greater than the distortional-deformation capability of the surrounding matrix material 16. In a fifth expression, the distortional-deformation capability of the veil-stabilized fabric 18 may be at least 40 percent greater than the distortional-deformation capability of the surrounding matrix material 16. In a sixth expression, the distortional-deformation capability of the veil-stabilized fabric 18 may be at least 50 percent greater than the distortional-deformation capability of the surrounding matrix material 16. Therefore, the composite 10 may exhibit a significant improvement in mechanical performance, such as increased tensile strength and/or strain.

The composite 10 may be designed or structured to have higher distortional loads and lower dilatation loads in order to increase von Mises strain. In one expression, the composite 10 may have a von Mises strain of at least 0.300. In another expression, the composite 10 may have a von Mises strain of at least 0.400. In still another expression, the composite 10 may be made of an amine and an epoxy (e.g., such as a composition including at least one diamine and at least one epoxy resin). In other embodiments, the composite may include varying von Mises strain results, and may be made of differing materials.

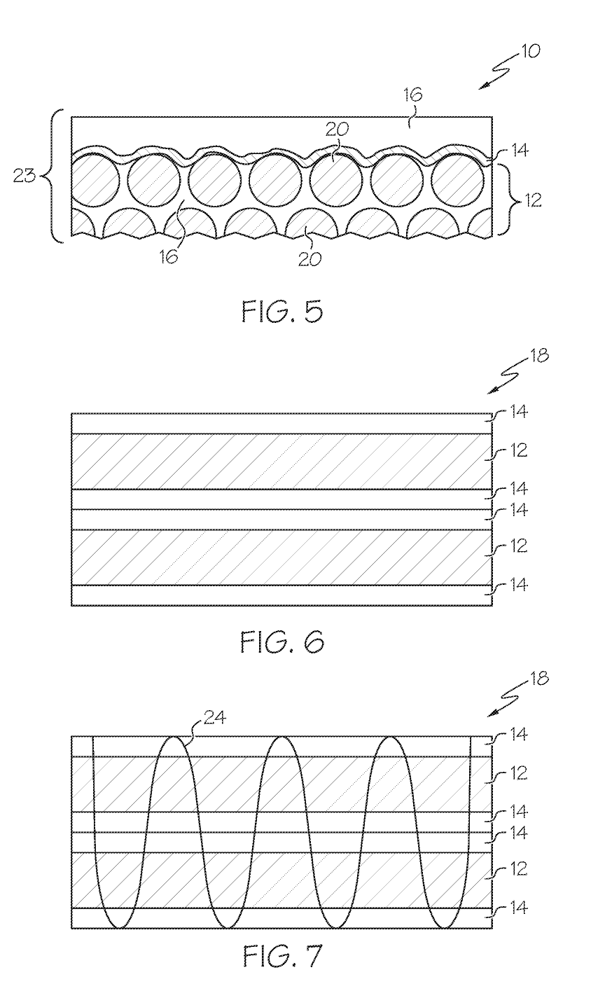

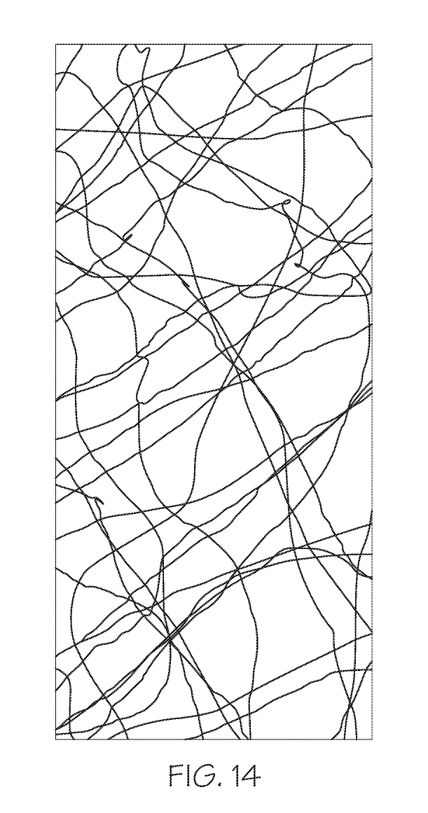

Referring to FIG. 5, which illustrates a schematic cross-section of single-ply of the disclosed composite 10. The interlayer 14 may be affixed to reinforcing fibers 20 between a fiber bed of the reinforcing layer 12 and a resin-rich zone 23 of matrix material 16. It can be appreciated that when the composite 10 is formed with multiple plies (i.e., layers), the resin-rich zone 23 extends between plies. In certain embodiments, as shown in FIG. 14, the interlayer 14 may not necessarily be present at all points along the reinforcing layer 12, but FIG. 5 reflects the in-plane geometry of the interlayer material (e.g., a nonwoven fabric) used to create the interlayer 14. In FIG. 14, veil areal weight and filament diameter will affect number of filaments per unit area and spacing between filaments. If the distortional strain capability of the interlayer 14 is sufficiently larger than that of the matrix material 16, then the interlayer 14 will distort and delay the onset of strain in the matrix material 16, such that the overall composite 10 is allowed to distort more than without the interlayer 14 to provide a composite 10 with higher tensile strength than would otherwise be possible from the same reinforcing fiber-matrix material combination. It can be appreciated that the interlayer 14 may be present in sufficient amount to provide this benefit.

Referring still to FIG. 5, each reinforcing layer 12 includes a fiber bed. For example, the fiber bed of the reinforcing layer 12 may include a unidirectional fabric made of reinforcing fibers 20. The reinforcing fibers 20 may be continuous or discontinuous (e.g., chopped or stretch-broken fibers) and may be formed from any of a variety of materials. In one example, the unidirectional reinforcing fibers 20 may be made of carbon fibers. Other examples of reinforcing fibers 20 include, without limitation, glass fibers, organic fibers, metallic fibers, ceramic fibers, and mineral fibers.

Each interlayer 14 may be formed of a nonwoven fabric, for example, a nonwoven fabric having continuous polymeric fibers. The interlayer 14 may be formed from any of a variety of thermoplastic materials, though non-thermoplastic fibers may be included without departing from the scope of the present disclosure. The interlayer fibers may be selected from among any type of fiber that is compatible with the thermosetting matrix material 16 used to form the composite 10. For example, the interlayer fibers may be selected from the group consisting of polyamide, polyimide, polyamide-imide, polyester, polybutadiene, polyurethane, polypropylene, polyetherimide, polysulfone, polyethersulfone, polyphenylsulfone, polyphenylene sulfide, polyetherketone, polyethertherketone, polyarylamide, polyketone, polyphthalamide, polyphenylenether, polybutylene terephthalate, polyethylene terephthalate, or polyesterpolyarylate (e.g. Vectran®).

The interlayer 14 may be nonwoven, for example a fabric that is spunbonded, spunlaced, or a mesh, where each interlayer 14 may be formed by an automated method and with relatively wide widths that can be difficult or impossible to form by braiding, weaving, and the like. Spunbonded fabrics may be produced from continuous fibers that are continuously spun and bonded thermally. These fabrics are commercially available from a wide variety of sources. Preferred fabrics have areal weights that are generally between 1 and 50 grams per square meter, and, more preferably, areal weights between 0.25 and 5% of the overall cured composite weight. Spunlaced fabrics may be prepared from continuous fibers that are continuously spun and bonded mechanically. These fabrics are commercially available from a wide variety of sources. Preferred spunlaced fabrics have areal weights that are generally in the same range as for spunbonded fabrics. Mesh fabric construction may contain between 0.5 and 15 threads per inch in the warp and weft directions.

Generally, the interlayers 14 may be formed of any of various polymeric fibers that are chemically compatible with the matrix material 16 (e.g., thermosetting resin) and that do not dissolve into the matrix material 16 during infusion and cure. For example, the interlayers 14 should not be soluble, to any great extent, in the underlying matrix material 16, except as to facilitate better contact and/or adhesion between the interlayer 14 and the matrix material 16. The melting point of the interlayer material should typically be near or above the gel temperature of the matrix material 16 to ensure that composite properties, such as elevated-temperature compression strength, are not compromised. The interlayer materials should also have good resistance to solvents like ketones, water, jet fuel, and brake fluids to ensure that the composite 10 does not become susceptible to strength degradation when exposed to such solvents.

The distortional-deformation capability of the composite 10, which may be expressed in terms of von Mises strain performance, should be high relative to the matrix material 16 (e.g., thermosetting polymeric resin) in order to achieve optimum reinforcing fiber-matrix material load transfer capability between the reinforcing material and the surrounding matrix material 16. The von Mises strain or stress is an index derived from combinations of principle stresses at any given point in a material to determine at which point in the material, stress will cause failure.

While the bulk polymer resin forming the matrix material 16 has a distortional-deformation capability lower than that of the polymeric fibers 22 of the interlayer material, exhibited by a lower von Mises strain performance, the overall mechanical performance of the composite 10 will be significantly improved due to the interlayers 14 surrounding the reinforcing layer 12 if the interlayer material is properly selected for compatibility with the matrix material 16. The interlayers 14 may also be beneficial in mitigating the effects of transverse microcracks created by excessive thermal strains, particularly in composites 10 using a high-temperature resin in the matrix material 16.

The matrix material 16 may include any polymeric resin or any other any suitable commercial or custom resin system having the desired physical properties, which are different from those of the interlayer 14. These differences in physical properties result in the interlayer 14 having a higher distortional-deformation capability than that of the matrix material 16. For example and without limitation, typical physical properties of the matrix material which may affect its distortional-deformation capability include, but are not limited to: superior fluid resistance, increased modulus, increased high-temperature performance, improved processability and/or handling properties (such as the degree of tack and tack life) relative to interlayer material.

Although the present disclosure is not limited to any particular theory of operation, it is believed that, in order for the interlayers 14 to provide a desired increase in the tensile strength of the resulting composite 10, the interlayer material should have some chemical compatibility with the matrix material 16 (e.g. chemical bonding, hydrogen bonding, etc.).

Referring back to FIGS. 3 and 4, in an implementation, one reinforcing layer 12 may be disposed between adjacent interlayers 14. The interlayers 14 may be bonded to the reinforcing layer 12 to form the veil-stabilized fabric 18. Referring to FIG. 6, in another implementation, two reinforcing layers 12 may be used to form the veil-stabilized fabric 18. Each interlayer 14 may be bonded to an associated reinforcing layer 12 to form the veil-stabilized fabric 18. In another implementation, three or more reinforcing layers 12 may be used. In another implementation, four to sixteen reinforcing layers 12 may be used. In another implementation, more than sixteen reinforcing layers 12 may be used.

In one embodiment, the interlayers 14 are melt-bonded to the reinforcing layer 12 upon which they are disposed. Such melt-bonding acts to maintain the orientation of the reinforcing fibers 20 of the reinforcing layer 12 in place during the layup of any multiplayer laminate and subsequent infusion of the matrix material 16.

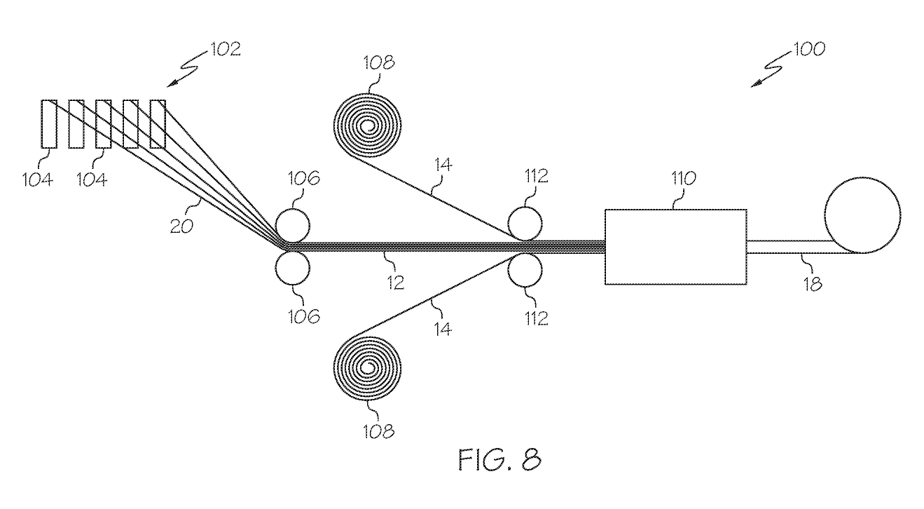

Referring to FIG. 7, a warp-knit composite may be assembled by knit-stitching the reinforcing layers 12 together with interlayers 14. The melt-bonding is performed first to make a unidirectional material or stabilized monolayer fabric that is then introduced into a warp-knitting machine. The knit thread or sewing thread 24 may be selected from a variety of materials, including without limitation, polyester-polyarylate (e.g. Vectran®), polyaramid (e.g. Kevlar®), polybenzoxazole (e.g. Zylon®), viscose (e.g. Rayon®), acrylic, polyamide, carbon, and fiberglass. Where desired, the knitting or sewing step may be carried out after the initial lay-up of the reinforcing layers 12 and the interlayers 14. The same kinds of threads may be used to hold locally different thicknesses mechanically in place by stitching or by tufting.

Multiple sewing threads 24 may be used to hold the veil-stabilized fabric 18 (i.e., reinforcing layers 12 and interlayers 14) of the composite 10 (FIG. 3) together. Each thread 24 (e.g., each stitch) may extend through each of the reinforcing layers 12 and the interlayers 14 of the veil-stabilized fabric 18 in alternate directions. Thus, all of the reinforcing layers 12 and interlayers 14 may be connected by stitching, with none of the reinforcing layers 12 and interlayers 14 being melt-bonded or otherwise bonded together. In this regard, the interlayer 16, in some cases, may provide little or no tackiness or stickiness for bonding or adhering to the reinforcing layers 12. Instead, the stitches may provide any necessary connection between the reinforcing layers 12 and interlayers 14 and/or mechanical fasteners may be provided for temporary or permanent connection of the reinforcement layers 12 and interlayers 16. Accordingly, the composite 10 may be formed without the use of “tackifiers (i.e., materials for bonding the reinforcing layers 12 and the interlayers 14). That is, the stitches may connect the reinforcing layers 12 and the interlayers 14 during stacking and during infusion of the matrix material 16. The lack of a tackifier between the reinforcing layers 12 and the interlayers 14 may increase the penetrability of the matrix material 16 within the composite 10 and thereby facilitate infusion of the reinforcing layers 12 and the interlayers 14 by the matrix material.

Referring to FIG. 8, in one embodiment of the disclosed system, generally designated 100, the reinforcing layers 12 may be prepared by laminating in which reinforcing fibers 20 are taken from a creel 102 containing multiple spools 104 of reinforcing fiber 20 (e.g., tow) that are spread to the desired width by spreader bars 106 and combined with the interlayers 14. A device, such as a laminator or horizontal oven combined with pressure rollers may be used to prepare the reinforcing layers 12 by providing tows of unidirectional reinforcing fibers 20 (e.g., carbon fibers) and then laminating a veil interlayer 14, fed from rollers 108, to the reinforcing layer 12. The interlayers 14 may be melt-bonded to one or both sides of reinforcing layer 12 under heat and/or pressure to produce a dry veil-stabilized fabric 18 having the interlayer 14 melt-bonded to the reinforcing layer 12, for example by an oven 110 and/or by passing between heated rollers 112.

FIG. 4 shows the construction of the veil-stabilized fabric 18 with interlayers 14 melt-bonded to both sides of the reinforcing layer 12. In an alternative embodiment, the interlayer 14 may be melt-bonded to only one side of the reinforcing material 12. However, it may be preferable to melt-bond the interlayer 14 on both sides of the reinforcing layer 12 to produce a veil-stabilized fabric 18 with easier handleability.

The composite 10 (FIG. 3) may be manufactured by a number of processes to produce prepregs or preforms that may be between 1 inches and 300 inches wide. Typically, the composite 10 may be at least about 50 inches wide.

In one implementation, the composite 10 may be produced as a preform that is subsequently molded using liquid resin infusion (e.g., liquid molding). The preform may include at least one veil-stabilized fabric 18 (i.e., a plurality of alternating reinforcing layers 12 and interlayers 14) laid-up in a mold. The veil-stabilized fabric 18 preform may be infused with the matrix material 16, such as a thermosetting resin, using liquid-molding to fully wet-out the preform. After infusion of the preform with the matrix material 16, the composite 10 may be heated in the mold to gel, set, and cure the matrix material 16 to form a final composite part.

In another implementation, the composite 10 may be produced as a pre-impregnated (i.e., prepreg) composite. The matrix material 16 is applied to the veil-stabilized fabric 18 prior to lay-up in a mold to form the prepreg. After preimpregnation of the veil-stabilized fabric 18 with the matrix material 16, the composite 10 may be laid-up and heated in the mold to gel, set, and cure the matrix material 16 to form a final composite part.

It is common to prepare composites made from multi-axial preform fabrics comprising two or more layers or laminae. Where desired, the pattern of laminae may be repeated to achieve a desired thickness. When it is desired to build-up a desired thickness, mirror-image composite lamina stacks may be used to prevent post-cure bending and twisting due to thermal stresses created after curing the resin at elevated temperatures. In such a case, the total lay-up may be made up of groups of balanced laminae, or laid-up alternately to balance the laminate. This practice is common in the field and is done to ensure the fabrication of parts without unwanted distortion.

In one embodiment, the composite material 10 may be laid-down in a quasi-isotropic pattern. A quasi-isotropic pattern is one that approximates an isotropic material in the plane of the fibers. This is also known as transverse isotropy. An example of a quasi-isotropic pattern is one with lamina laid-down in a 0/+45/90/−45 pattern. Another quasi-isotropic pattern may include a +45/0/45/−90 pattern. Another quasi-isotropic pattern may include a −45/0/+45/90 pattern. Still another quasi-isotropic pattern may include a 0/+60/−60 pattern.

In another embodiment, the composite material 10 may be laid-down in an orthotropic pattern. Orthotropic means having fibers or units such that the net result is not quasi-isotropic in plane like quasi-isotropic patterns. An example of an orthotropic pattern is one with 44% 0°, 22% +45°, 22% −45° and 12% 90° fibers. In this example, greater longitudinal strength (along the 0°-direction) and lower shear strength (±45°-direction) and transverse strength (90° direction) than a quasi-isotropic (25/50/25) lay-up are achieved. The resulting built-up lamina provide higher strength and thickness in the 0° direction as compared to a quasi-isotropic laminate, but provide lower shear strength and thickness (provided by the ±45° layers). Correspondingly, in the example, the 90° strength is lower than a quasi-tropic laminate. The term orthotropic is well understood in the field. For example a 0° fabric is orthotropic, as well as any other pattern that does not result in balanced average in plane (i.e. quasi-isotropic) properties. Additionally, angles different from 0°, 90°, and ±45° may be selected as needed or preferred to obtain a desired strength and stiffness.

In whichever process used, the interlayers 14 are lightweight and porous to minimize distortion of the reinforcing layers 12 and reduce the resistance of a flow of the matrix material 16 through the interlayers 14 during infusion of the matrix material 16 into the reinforcing layers 12.

The interlayers 14 may be formed of materials that improve specific characteristics of the resulting composite 10, such as the tensile strength, regardless of the tackiness of the interlayer material. The interlayer 14 should be formed of a material having a higher distortional-deformation capability than that of the matrix material 16. The tensile strength of the resulting composite 10 may be greater, in some cases, than the tensile strength that is achieved in a composite of similar dimensions that may be formed with interlayers made from different materials. Further, the tensile strength of the resulting composite material 10 may be greater, in some cases, than the tensile strength that can be achieved in a composite of similar dimensions that is formed with the reinforcing layers disposed adjacently with no interlayers therebetween. Thus, increasing the distortional-deformation capability of the interlayer 14 should generally increase the tensile strength of the composite material 10.

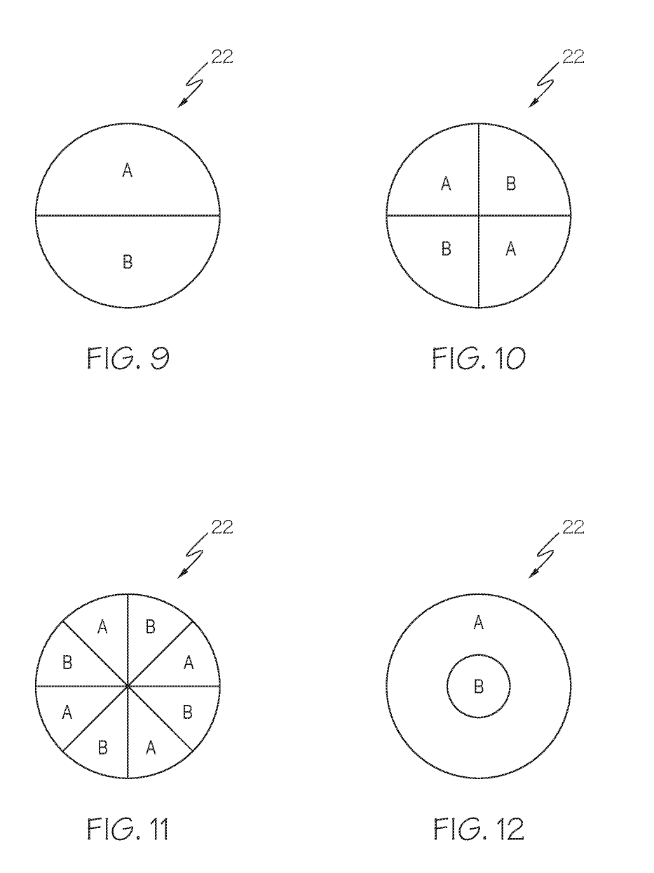

The interlayer 14 may be made from a single material or two or more materials. Referring to FIGS. 9-12, the interlayer fibers may include bi-component fibers that may be used instead of mono-component fibers. For example, the two or more materials may be prepared by mechanically mixing different fibers, which are used to create the spunbonded, spunlaced, or mesh fabric interlayer material. The two or more materials may be used to form a bi-component fiber, tri-component fiber or higher component fiber to create the interlayer material. Non-limiting examples of bi-component fibers are illustrated schematically in FIGS. 9-12. For example, FIG. 9 shows in cross-section a fiber made by coextrusion of a fiber material A and a fiber material B. Such a fiber may be produced by a spinneret with two outlets. As another example, FIG. 10 shows a bi-component fiber made from materials A and B, as would be produced by extrusion through four spinnerets. As another example, FIG. 11 shows a bi-component fiber made from materials A and B, as would be produced by extrusion through eight spinnerets. As yet another example, the bi-component fiber may be used in the form of a core sheath fiber, such as illustrated in FIG. 12. In a core sheath fiber, a fiber material of one type, illustrated as B in FIG. 12 may be extruded as the core, while a fiber material of another type, illustrated as A in FIG. 12 may be extruded as the sheath. For example, bi-component fibers may be made of polyurethane and a polyamide. As another example, the sheath may be made of polyurethane and the core may be made of a polyamide.

Bi-component fibers, such as those illustrated in FIGS. 9-12, and other fibers containing more than two components are well known in the art and can be made by a number of conventional procedures. Additionally, although the fibers in FIGS. 9-12 are illustrated schematically with circular cross-sections, it can be appreciated that other cross-sections may be used.

In one embodiment of a multicomponent interlayer 14 made by mechanically mixing different fibers, non-thermoplastic fibers may be combined with thermoplastic ones to enable a mixed-material interlayer that is still capable of being melt-bonded to the reinforcing fibers 12 to form preform fabrics or prepregs. Examples, without limit, of non-thermoplastic fibers include: felts or mats made from carbon fibers, carbon nanofibers, and/or carbon nanotubes; felts or mats made from glass, ceramic, metallic, or mineral fibers or whiskers; carbon fibers, carbon nanofibers, carbon nanotubes, glass fibers, ceramic fibers, metallic fibers, mineral fibers, or polymeric fibers such as para-aramid (e.g. Kevlar, Twaron), viscose (e.g. Rayon), or other thermoset-based fibers that are deposited directly onto thermoplastic veils with or without a binder and processed with or without heating to aid in fixing the non-thermoplastic fibers to the thermoplastic ones. Additionally, combinations of these materials are also possible. In these examples, as long as the combination of the thermoplastic and other fibers produces an interlayer 14 with a distortional capability greater than that of the matrix 16, it should be possible to increase the overall tensile strength of the composite material 10.

In one implementation, the fibers 22 making up the interlayer material may have diameters from 1 to 100 microns. In another implementation, the fibers 22 making up the interlayer material may have diameters from 10 to 75 microns. In another implementation, the fibers 22 making up the interlayer material may have diameters from 10 to 30 microns. In another implementation, the fibers 22 making up the interlayer material may have diameters from 1 to 15 microns. In another implementation, the fibers 22 making up the interlayer comprise a combination of different filament diameters.

As described above, the veil-stabilized fabric 18 may include a single reinforcing layer 12 (FIG. 4) or a plurality of reinforcing layers 12 (FIG. 6). Although a single ply of veil-stabilized fabric 18 may be infused with the matrix material 16 by pre-impregnating to form an uncured composite 10, it is much more preferable to use multiple plies of veil-stabilized fabric 18 that may be infused with the matrix material 16 by a variety of liquid-molding processes to form a composite 10 that can subsequently be cured to form a solid laminate. For example, in one process, vacuum-assisted resin transfer molding, a matrix material 16, such as a resin, is introduced to a mold containing multiple plies of veil-stabilized fabric 18 under vacuum.

The mold typically defines one or more surfaces corresponding to a desired contour of the finished composite part so that the multiple plies of veil-stabilized fabric 18 are supported in the desired configuration. The matrix material 16 infuses the plies of veil-stabilized fabric 18 and saturates the reinforcing layers 12 between the interlayers 14. The interlayers 14 must be made of a material that is permeable to permit the flow of the matrix material 16 during liquid molding. Optionally, the stitches 24 (FIG. 7) between the reinforcing layers 12 and interlayers 14 may hold each veil-stabilized fabric 18 in place during infusion of the matrix material 16.

The mold may be a closed vessel-like device for containing the vacuum. In another process, typically referred to as resin transfer molding, the matrix material 16 (e.g., thermosetting resin) is infused under pressure into a closed mold. Preferably, the mold is encapsulated in a sealed bag such that resin is introduced into and air and volatiles are removed from inside the bag. It can be appreciated that other liquid-molding processes may be used to prepare the cured composite 10.

Following infusion of the matrix material 16 in a process such as those described above, the mold may be heated to cure the matrix material 16 to produce a cured composite 10 (e.g., the finished composite part). During heating, the matrix material 16 reacts with itself to form crosslinks in the matrix of the composite 10. After an initial period of heating, the matrix material 16 gels. At gel, the matrix material 16 no longer flows, but rather behaves as a solid. Preferably, the matrix material 16 is gelled at a temperature that is below the melting point of the interlayer material of the interlayer 14 in order to prevent the melting and flowing of the interlayer material into the reinforcing material. After gel, the temperature may be ramped up to a final temperature to complete the cure. The final cure temperature depends on the nature and properties of the matrix material 16 chosen. For the case of aerospace-grade epoxy resins, it is conventional to ramp the temperature after gel up to a temperature range of 325 to 375° F. and hold at this temperature for 1 to 6 hours to complete the cure.

The resulting composite 10 formed from at least one veil-stabilized fabric 18 has been shown to significantly increase the tensile strength of the composite 10 compared to unmodified composites. The study of strength-critical structure has compared the design and construction of the disclosed composite 10 having a highly distortionally capable interlayer 14 present along the structural reinforcing fibers 20 and in full contact with the matrix material 16. The composite 10 was tested for Open Hole Tensile (OHT) strength measured in kilopound per square inch (ksi). The performance results of the OHT tests were compared to panels made and tested according to ASTM D5766.

One set of OHT tests showed that a composite 10 formed using Cycom 5320-1 resin, commercially available from Cytec Industries Inc., part of Cytec Solvay Group, of Woodland Park, N.J., and Torayca T800S reinforcing fibers, commercially available from Toray Industries, Inc. of Tokyo, Japan, with the interlayers to form a veil-stabilized composite had increased tensile strength performance of 20% to 30% compared to the reference material with no interlayer.

Another set of OHT tests showed that a composite 10 formed using Cycom 5320-1 resin and Torayca T800S reinforcing fibers with the interlayers to form a veil-stabilized composite had increased tensile strength performance of 10% to 20% compared to the reference material with no interlayer at a temperature of −75° F.

Another set of OHT tests showed that a composite 10 formed using Cycom 970 resin, commercially available from Cytec Industries Inc., part of Cytec Solvay Group, of Woodland Park, N.J., and PA1470 veil interlayer, commercially available from Spunfab Ltd. of Cuyahoga Falls, Ohio, with T300-3K-70-P reinforcing fibers (e.g., fabric), commercially available from Toray Industries, Inc. of Tokyo, Japan, to form a veil-stabilized composite had increased tensile strength performance of 5% to 15% compared to the same material without an interlayer.

Additionally, if selected properly, the disclosed composite 10 containing interlayers 14 may possess both improved tensile strength and improved resistance to impact damage. For example, a composite 10 formed using Cycom 970 resin and PA1470 veil interlayer with T300-3K-70-P reinforcing fibers (e.g., fabric) to form a veil-stabilized composite had increased compression-after-impact strength performance of 50-55% compared to the same material without an interlayer.

It is hypothesized that that a composite 10 formed of at least one veil-stabilized fabric may improve distortional-deformation capability due to a transfer of load around micro-scale flaws in the reinforcing material, which may be considered failure initiation sites along a longitudinal axis, when the reinforcing fiber experiences a load. This ability to redistribute the load around flaws may allow the composite 10 to continue to sustain load without failure.

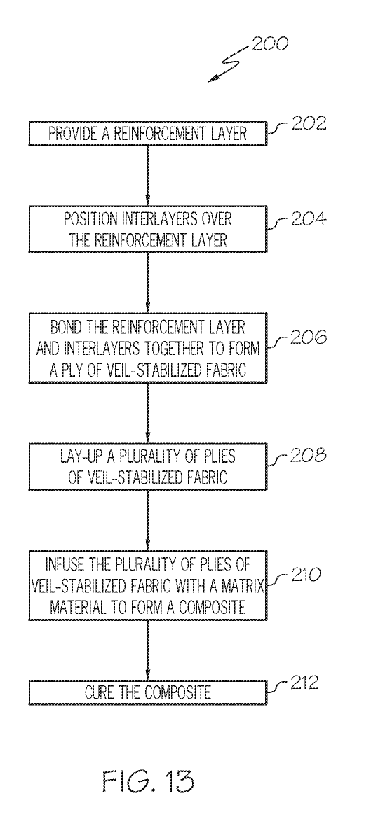

Referring to FIG. 13, also disclosed is a method, generally designed 200, for making a veil-stabilized composite. The method 200 may begin at block 202 with the step of providing at least one reinforcing layer. Each reinforcing layer may be formed of a plurality of structural reinforcing fibers.

As shown at block 204, at least one interlayer may be positioned over the reinforcing layer. Each interlayer may be formed of a plurality of nonwoven polymeric fibers. The interlayer may have a first distortional-deformation capability.

As shown at block 206, the reinforcing layer and the interlayers may be bonded together to form a ply of veil-stabilized fabric. The veil-stabilized fabric (i.e., at least one interlayer bonded to at least one reinforcing layer) may be infused with matrix material in either a prepreg approach or a preform approach. In either approach, the reinforcing layer and interlayers may be bonded together to form an individual ply of veil-stabilized fabric prior to infusion of the matrix material. The matrix material may have a second distortional-deformation capability. The first distortional-deformation capability may be greater than the second distortional-deformation capability.

In the preform approach, at least one ply of the veil-stabilized fabric may be formed to the shape of a final composite part, for example in a mold. As shown in block 208, in another implementation, a plurality of plies may be laid-up, for example in a mold, to form the shape of a final composite part.

As shown at block 210, the matrix material may be infused into the plurality of laid-up plies of the veil-stabilized fabric to form a consolidated composite.

As shown at block 212, the composite (i.e., at least one ply of the veil-stabilized fabric infused with the matrix material) may be cured, for example in an oven, to form a cured composite part.

In the prepreg approach, blocks 208 and 210 may be reversed. Each ply of the veil-stabilized fabric may be infused, for example coated on at least one side, with the matrix material to form a consolidated composite. Optionally, the veil-stabilized composite may then be partially cured. Each ply of the partially cured veil-stabilized composite may then be covered for storage and/or transportation. A plurality of plies of the veil-stabilized composite may be laid-up to form the shape of the final composite part, for example in a mold having the shape of the composite part. The composite may be cured, for example in an oven, to form the cured composite part.

Accordingly, the disclosed composite 10 may have a relatively high distortional-deformation capability (e.g., tensile strength) compared to that of a reinforcing layer surrounded by a matrix material. This allows for a higher strength composite to be produced without the need for higher cost and higher strength reinforcing fibers. A properly selected interlayer bonded to a reinforcing layer forms a veil-stabilized fabric that creates a region surrounding the reinforcing fibers of the reinforcing layer that optimizes matrix material-fiber load transfer across fiber discontinuities or defects, thereby improving the mechanical properties of the composite material.

Although various aspects of the disclosed composite material have been shown and described, modifications may occur to those skilled in the art upon reading the specification. The present application includes such modifications and is limited only by the scope of the claims.

What is claimed is:

1. A method for manufacturing a composite, said method comprising:
selecting an interlayer material having a first distortional-deformation capability;
selecting a matrix material having a second distortional-deformation capability, which is less than said first distortional-deformation capability;
disposing at least one reinforcing layer, formed of reinforcing fibers of a reinforcing material, and at least one interlayer, formed of a nonwoven fabric of said interlayer material, in an alternating configuration; and
infusing said at least one reinforcing layer and said at least one interlayer with said matrix material such that said matrix material flows though said at least one reinforcing layer and said at least one interlayer,
wherein selection of said interlayer material having said first distortional-deformation capability and said matrix material having said second distortional-deformation capability is configured to increase tensile strength of said composite.

2. The method of claim 1 wherein said first distortional-deformation capability is at least approximately 10 percent greater than said second distortional-deformation capability.

3. The method of claim 2 wherein:
said first distortional-deformation capability corresponds to a first von Mises strain of said interlayer material, and
said second distortional-deformation capability corresponds to a second von Mises strain of said matrix material, which is less than said first von Mises strain.

4. The method of claim 3 further comprising curing said matrix material to form a cured composite.

5. The method of claim 4 wherein said cured composite has an overall distortional-deformation capability, which is greater than said second distortional-deformation capability, and wherein said overall distortional-deformation capability corresponds to an overall von Mises strain of said cured composite.

6. The method of claim 5 wherein said overall von Mises strain is at least approximately 0.3.

7. The method of claim 1 further comprising melt-bonding said at least one interlayer and said at least one reinforcing layer together.

8. The method of claim 1 further comprising knit-stitching said at least one interlayer and said at least one reinforcing layer together.

9. The method of claim 1 wherein said infusing step comprises one of pre-impregnating said at least one reinforcing layer and said at least one interlayer with said matrix material or liquid molding said at least one reinforcing layer and said at least one interlayer with said matrix material.

10. The method of claim 1 wherein:
said interlayer material is insoluble in said matrix material, and
said matrix material has a gel temperature that is below a melting temperature of said interlayer material.

11. The method of claim 1 wherein said interlayer material comprises continuous polymeric fibers.

12. A method for manufacturing a composite, said method comprising:
selecting an interlayer material having a first distortional-deformation capability;
selecting a matrix material having a second distortional-deformation capability, which is less than said first distortional-deformation capability;
disposing a plurality of reinforcing layers, formed of reinforcing fibers of a reinforcing material, and a plurality of interlayers, formed of a nonwoven fabric of said interlayer material, in an alternating configuration; and
infusing said plurality of reinforcing layers and said plurality of interlayers with said matrix material such that said matrix material flows though said plurality of reinforcing layers and said plurality of interlayers,
wherein selection of said interlayer material having said first distortional-deformation capability and said matrix material having said second distortional-deformation capability is configured to provide a cured composite having an overall distortional-deformation capability, which is greater than said second distortional-deformation capability, to increase tensile strength of said cured composite.

13. The method of claim 12 wherein:
said first distortional-deformation capability corresponds to a first von Mises strain of said interlayer material,
said second distortional-deformation capability corresponds to a second von Mises strain of said matrix material, which is less than said first von Mises strain, and
said overall distortional-deformation capability corresponds to an overall von Mises strain of said cured composite, which is greater than said second von Mises strain.

14. The method of claim 12 further comprising bonding one of said plurality of interlayers to at least one surface of one of said plurality of reinforcing layers to form an interlayer-stabilized fabric.

15. The method of claim 14 wherein:
said infusing step comprises pre-impregnating said interlayer-stabilized fabric with said matrix material, and
said disposing step comprises laying up a plurality of layers of said interlayer-stabilized fabric pre-impregnating with said matrix material.

16. The method of claim 14 wherein:
said disposing step comprises laying up a plurality of layers of said interlayer-stabilized fabric, and
said infusing step comprises liquid molding said plurality of layers of said interlayer-stabilized fabric with said matrix material.

17. A method for improving tensile strength of a composite comprising at least one reinforcing layer, formed of reinforcing fibers of a reinforcing material, and at least one interlayer, formed of a nonwoven fabric of an interlayer material, disposed in an alternating configuration and infused with a matrix material, said method comprising:
selecting said interlayer material having a first distortional-deformation capability; and
selecting said matrix material having a second distortional-deformation capability, which is less than said first distortional-deformation capability,
wherein selection of said interlayer material having said first distortional-deformation capability and said matrix material having said second distortional-deformation capability is configured to increase tensile strength of said composite.

18. The method of claim 17 wherein said first distortional-deformation capability is at least approximately 10 percent greater than said second distortional-deformation capability.

19. The method of claim 17 wherein:
said composite has an overall distortional-deformation capability, which is greater than said second distortional-deformation capability, and
selection of said interlayer material having said first distortional-deformation capability and said matrix material having said second distortional-deformation capability is configured to increase said tensile strength of said composite by at least approximately 10 percent.

20. The method of claim 19 wherein:
said first distortional-deformation capability corresponds to a first von Mises strain of said interlayer material,
said second distortional-deformation capability corresponds to a second von Mises strain of said matrix material, which is less than said first von Mises strain, and
said overall distortional-deformation capability corresponds to an overall von Mises strain of said cured composite, which is greater than said second von Mises strain.
